(19) United States
(12) Patent Application Publication
(10) Pub. No.: US 2013/0159951 A1
(43) Pub. Date: Jun. 20, 2013

(54) SIGNAL SIMULATION DEVICE, SIGNAL RECORDING AND SIMULATION TESTING METHOD

(71) Applicants: Hsueh-Chih LU, Taipei (TW); Po-Jui CHEN, Taipei (TW)

(72) Inventors: Hsueh-Chih LU, Taipei (TW); Po-Jui CHEN, Taipei (TW)

(21) Appl. No.: 13/431,375

(22) Filed: Mar. 27, 2012

(30) Foreign Application Priority Data
Dec. 16, 2011 (TW) 100146923

(51) Int. Cl. G06F 9/455

(52) U.S. Cl. 716/113

(57) ABSTRACT

A signal simulation device, a signal recording and simulation testing method for capturing a testing signal sent out by a test host and sending out a corresponding testing signal to a to-be-tested device. The signal simulation device comprises an input interface, a timer, a processing unit and a signal capturing unit. The signal capturing unit is electrically connected to the input interface, the timer and the processing unit. The testing signal is recorded by the signal capturing unit through the input interface. When the signal simulation device is switched to a recording status, the signal simulation device is electrically connected to the test host through the input interface to receive the testing signal. The clock cycle of the timer is adjusted according to the testing signal. The processing unit is used for setting the clock cycle of the timer.

### CROSS-REFERENCE TO RELATED APPLICATIONS

This non-provisional application claims priority under 35 U.S.C. §119(a) on Patent Application No(s). 100146923 filed in Taiwan, R.O.C. on Dec. 16, 2011, the entire contents of which are hereby incorporated by reference.

### BACKGROUND

1. Technical Field

The present disclosure relates to an electronic simulation device, a recording and testing method and more particularly to a signal simulation device, a signal recording and a signal simulation testing method.

2. Related Art

Because of the rapid development of the micro-electro-mechanical technique, a test host can be connected to various types of to-be-tested devices. In order to ensure that the test host can communicate correctly with the to-be-tested devices, developers have to know the operations of the integrated circuits (IC) used in the to-be-tested devices. Generally, there is a specification for each of the integrated circuits and the operating pulse, switching waveform or operating waveform of the IC are recorded in the specification. Therefore, the developers have to be familiar with the specification of each of the IC for developing and debugging IC.

Furthermore, a micro control unit (MCU) is employed to send out control commands and waveforms for testing the IC. An operating frequency and the number of the pins of the IC are determined by the type of the MCU which is also another thing the developers have to consider in developing and debugging IC. Furthermore, for the production line, connecting each of the pins of the IC to the MUC is a time consuming task. Therefore, the overall testing efficiency is slowed down.

### SUMMARY

A signal simulation device provided by the disclosure comprises an input interface, a timer, a processing unit, a storage unit and a signal capturing unit. The input interface is electrically connected to a test host for receiving a testing signal. The timer has a clock cycle. The processing unit is used for setting the clock cycle of the timer according to the testing signal. The signal capturing unit is electrically connected to the input interface, the timer and the processing unit, and the testing signal is recorded by the signal capturing unit through the input interface.

A signal recording method is further provided by the disclosure, the method includes following steps of: the clock cycle of the signal simulation device are adjusted; the signal simulation device is connected to the test host for receiving the testing signal; and the testing signal is recorded and stored in the storage unit by the signal capturing unit based on the clock cycle.

Besides the signal recording method, a signal simulation testing method is further provided by the disclosure for processing corresponding tests for the to-be-tested device. The signal simulation testing method includes steps of: the signal simulation device is connected to the to-be-tested device; the corresponding clock cycle are selected for the to-be-tested device; and the segmented testing signal is sent out to the to-be-tested device sequentially by the processing unit based on the clock cycle.

The present invention will become more fully understood by reference to the following detailed description thereof when read in conjunction with the attached drawings.

### BRIEF DESCRIPTION OF THE DRAWINGS

The present disclosure will become more fully understood from the detailed description given herein below for illustration only, and thus are not limitative of the present disclosure, and wherein:

FIG. 1A is a framework diagram of the disclosure;

FIG. 1B is a framework diagram of a signal simulation device of the disclosure;

FIG. 2 is a comparison illustration of clock cycle and a testing signal of the disclosure; and

FIG. 3 is an operational flow chart of the disclosure.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

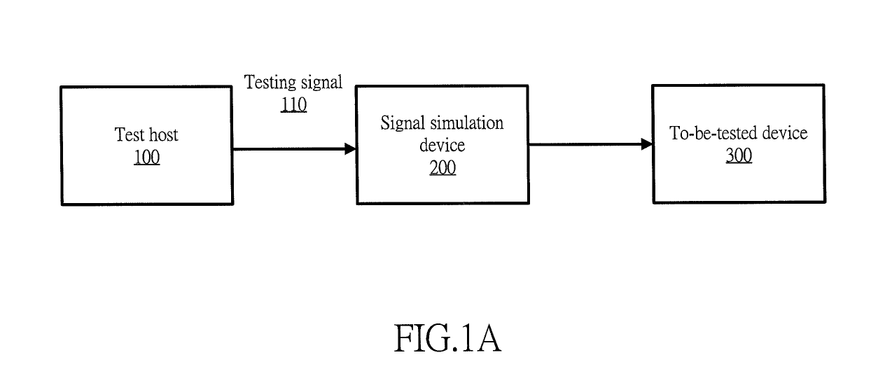

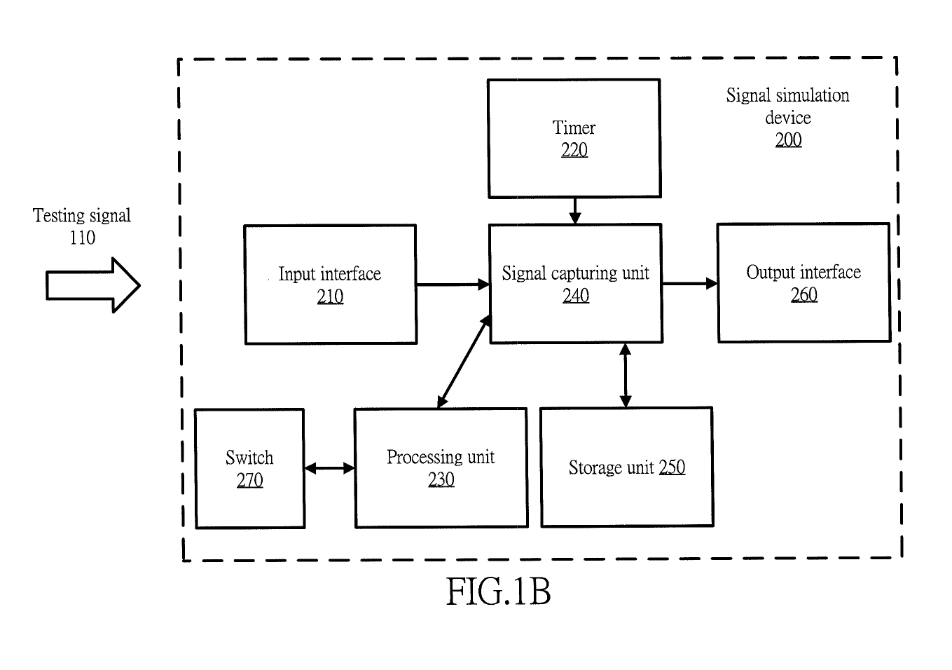

A test host 100 of the disclosure can be applied in personal computer, notebook, server or other electronic computing devices. Referring to FIG. 1A, which is a block diagram of a signal recording and testing system. The signal recording and testing system of the disclosure comprises the test host 100, a to-be-tested device 300 and a signal simulation device 200. The signal simulation device 200 can be connected only with the test host 100 or only with the to-be-tested device 300, or it can also be connected to both the test host 100 and the to-be-tested device 300. The to-be-tested device 300 can be a light emitting diode (LED), a beeper, a slave IC, a serial IC or other unidirectional transmission devices, but it is not limited to them.

FIG. 1B is a block diagram of the signal simulation device 200 of the disclosure. The signal simulation device 200 comprises an input interface 210, a timer 220, a processing unit 230, a signal capturing unit 240, a storage unit 250 and an output interface 260. The input interface 210 is electrically connected to the test host 100. The signal capturing unit 240 is electrically connected to the input interface 210, the timer 220, the processing unit 230, the storage unit 250, the output interface 260 and a switch 270. The output interface 260 is electrically connected to the to-be-tested device 300. The number of the output interface 260 is determined based on the number of the to-be-tested devices 300. Only one output interface 260 is illustrated in FIG. 1B for the sake of simplification but the disclosure is not limited to it.

The input interface 210 is used for receiving a testing signal 110 sent by the test host 100 and transmitting the testing signal 110 to the signal capturing unit 240 and the processing unit 230. The signal capturing unit 240 can be embodied by employing a field-programmable gate array (FPGA) or a complex programmable logic device (CPLD). The types of the input interface 210 and the output interface 260 are determined based on the types of connecting ports of the test host 100 and the to-be-tested device 300.

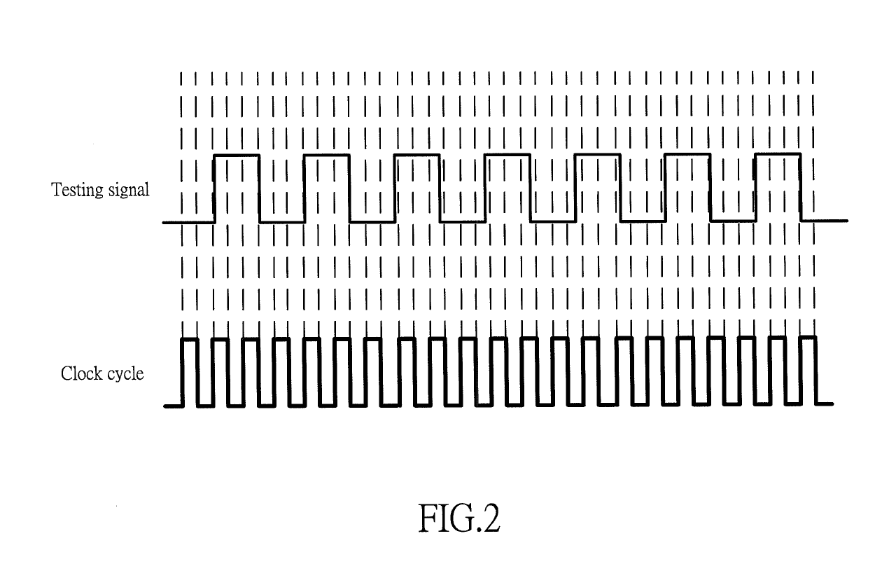

The processing unit 230 adjusts the clock cycle of the timer 220 according to the testing signal 110. When the testing signal 110 is received by the signal capturing unit 240, the testing signal 110 is segmented according to the clock cycle of the timer 220 at a regular interval by the signal capturing unit 240. Referring to FIG. 2, the segmented testing signal 110 is recorded sequentially in the storage unit 250 by the signal capturing unit 240. Because the period of the clock cycle are shorter than the period of the testing signal 110, the waveform changes of the testing signal 110 in each of the clock cycle can be recorded. The waveform of the testing signal 110 in each of the clock cycle is then recorded sequentially in the storage unit 250 by the processing unit 230.

The testing signal 110 is transmitted to the output interface 260 by the signal capturing unit 240, and the testing signal 110 is then transmitted to the to-be-tested device 300 through the output interface 260. Each of the testing signals 110 is received by the processing unit 230, the processing unit 230 will assign a serial number to the recorded testing signal 110 for the convenience of the developer to use during testing.

After the testing signal 110 is recorded, the signal simulation device 200 can be connected to other to-be-tested devices of the same type by the developer. In order that two different statuses of recording and testing can be differentiated by the disclosure, the recording and testing are switched by using the switch 270. The switch 270 can be embodied by hardware but it is not limited by it. In some embodiments, software or firmware can also be used. For example, a DIP switch can be used as the switch 270 by the developer. For the sake of clarification, the period for recording the testing signal 110 is defined as a recording status, and the period for testing the to-be-tested device 300 by the signal simulation device 200 is defined as a testing status. When the switch 270 is in the recording status, the inputted testing signal 110 can be recorded by the signal simulation device 200. When the switch 270 is in the testing status, the to-be-tested device 300 can be tested by the signal simulation device 200.

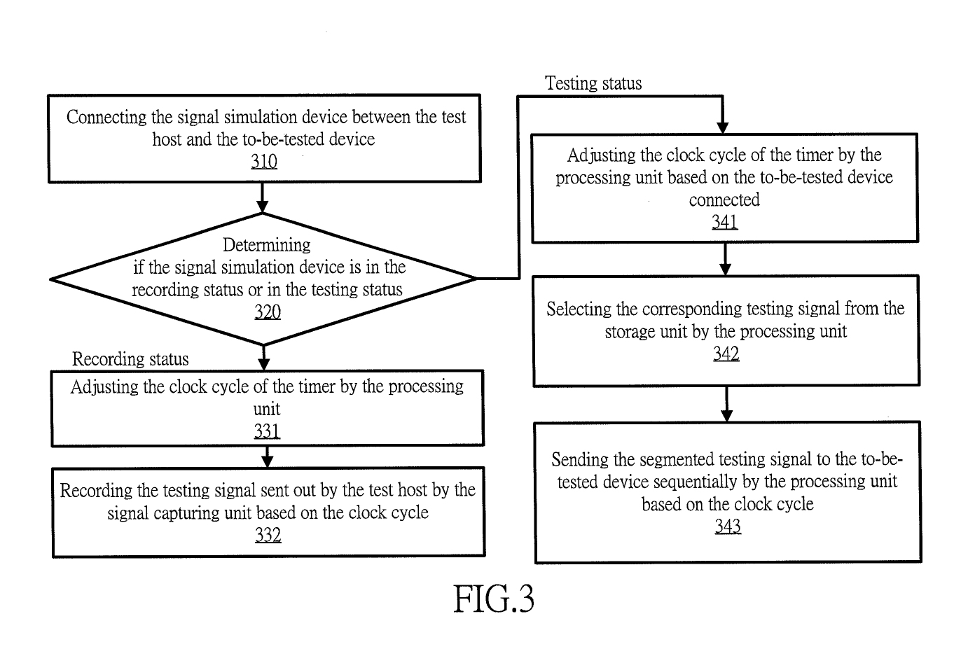

Please refer to FIG. 3 for detailed descriptions of the overall recording and testing procedures. FIG. 3 is an operational flow chart of the disclosure. An operational method of the disclosure includes following steps of:

step 310: the signal simulation device is connected between the test host and the to-be-tested device;

step 320: it is determined that whether the signal simulation device is in the recording status or in the testing status;

step 331: if the signal simulation device is in the recording status, the clock cycle of the timer is adjusted by the processing unit;

step 332: the testing signal sent out by the test host is recorded by the signal capturing unit based on the clock cycle

step 341: if the signal simulation device is in the testing status, the clock cycle of the timer is adjusted by the processing unit based on the to-be-tested device connected to the signal simulation device 200;

step 342: the corresponding testing signal is selected from the storage unit by the processing unit; and

step 343: the segmented testing signal is sent to the to-be-tested device sequentially by the processing unit based on the clock cycle.

In the recording status, the signal simulation device 200 is connected to the test host 100. In the testing status, the signal simulation device 200 is connected to the to-be-tested device 300. Then, either the recording status or the testing status is determined to be performed by the signal simulation device 200 based on the status of the switch 270. The recording by the signal simulation device 200 can be referred to the aforementioned context which will not be mentioned herein again.

If the signal simulation device 200 is in the testing status, the clock cycle of the timer 220 are adjusted by the processing unit 230 based on the to-be-tested device 300 connected to the signal simulation device 200. The testing signal 110 is recorded based on different clock cycle for different to-be-tested devices 200. In order to test the to-be-tested devices of the same type, the corresponding clock cycle is used by the processing unit 230 based on the type of the to-be-tested devices. After the clock cycle are selected, the segmented testing signal 110 in the storage unit 250 is read by segment in sequence by the processing unit 230 based on the selected clock cycle. The segmented testing signal 110 is then sent sequentially to the to-be-tested device 300 by the processing unit 230. The same reaction is outputted by the to-be-tested device 300 after the testing signal 110 is received. Therefore, there is no need for the developer to learn the commands of the to-be-tested device, and the recorded testing signal 110 can be used directly for obtaining the same result.

In the disclosure, the signal simulation device 30 is further disposed between the test host 100 and the peripheral devices, and the testing signal 110 to the signal simulation device 30 is recorded by the signal simulation device 200. After the recording of the testing signal 110 is completed by the signal simulation device 200, the signal simulation device 200 can then be connected to other to-be-tested devices by the user. The recorded testing signal 110 is sent out to the to-be-tested devices through the signal simulation device 200 by the user. Thereby, the to-be-tested devices can be tested without connecting to the test host 100.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A signal simulation device for capturing a testing signal sent out by a test host and sending out the corresponding testing signal to a to-be-tested device, the signal simulation device comprising:
an input interface electrically connected to the test host for receiving the testing signal;
a timer having a clock cycle;
a processing unit for setting the clock cycle of the timer according to the testing signal;
a signal capturing unit electrically connected to the input interface, the timer and the processing unit, the testing signal being recorded by the signal capturing unit through the input interface; and
a storage unit for storing a signal waveform of the testing signal recorded by the signal capturing unit.

2. The signal simulation device as claimed in claim 1, further comprising an output interface, the corresponding testing signal being selected by the processing unit based on the type of the to-be-tested device, and the corresponding testing signal being transmitted to the to-be-tested device through the output interface.

3. A signal recording method for capturing a testing signal sent out by a test host, the signal recording method comprising steps of:
adjusting a clock cycle of a signal simulation device;
connecting the signal simulation device to the test host for receiving the testing signal; and
recording the testing signal and storing it in a storage unit by the signal capturing unit based on the clock cycle.

4. The signal recording method as claimed in claim 3, further comprising:
before adjusting the clock cycle, switching the signal simulation device to a recording status.

5. A simulation testing method using the signal recording method of claim 3 for sending out the corresponding testing signal to a to-be-tested device, the simulation testing method comprising steps of:
connecting the signal simulation device to the to-be-tested device;
selecting the clock cycle corresponding to the to-be-tested device; and
sending out the segmented testing signal to the to-be-tested device sequentially by the processing unit based on the clock cycle.

6. The simulation testing method as claimed in claim 5, further comprising:
after connecting the to-be-tested device to the signal simulation device, switching the signal simulation device to a testing status.
